(19) United States
(12) Patent Application Publication
(10) Pub. No.: US 2015/0084414 A1
(43) Pub. Date: Mar. 26, 2015

(54) ISOLATION CONTACTOR TRANSITION POLARITY CONTROL

(71) Applicant: Jay E. Bissontz, Fort Wayne, IN (US)

(72) Inventor: Jay E. Bissontz, Fort Wayne, IN (US)

(73) Assignee: International Truck Intellectual Property Company, LLC, Lisle, IL (US)

(21) Appl. No.: 14/397,786

(22) PCT Filed: May 10, 2012
(86) PCT No.: PCT/US12/37195

§ 371 Date: Oct. 29, 2014

(51) Int. Cl. H02J 7/00; B60L 11/18

(52) U.S. Cl. CPC H02J 7/0057; B60L 11/1809; H02J 7/0072
USPC 307/10.1; 307/25

(57) ABSTRACT

An electrical power distribution system includes a dual mode electrical motor/generator, high voltage traction batteries, bi-directional direct current power transmission lines connectable between the dual mode electrical motor/generator and the high voltage traction batteries, first and second isolation contactors including magnetic blow out and connected into the power transmission lines to exhibit opposed polarity and an electrical system controller. In order to deenergize the electrical power distribution system the polarity of current on the bi-directional transmission lines is determined. Once the polarity has been determined the isolation contactor of corresponding polarity is selected to be opened.

### BACKGROUND

1. Technical Field

The technical field relates generally to electric and hybrid-electric motor vehicles and, more particularly, to control over state changes of high voltage isolation contactors used on such vehicles.

2. Description of the Technical Field

Hybrid electric vehicles are usually equipped with one or more high voltage direct current electrical power distribution subsystems over which power is supplied to vehicle traction motors and other high voltage loads. A representative configuration of such power subsystems might include two 350 volt direct current (DC) sub-systems and one 700 volt DC sub-system or bus. Current flow between hybrid-electric drive train motor/generator(s), or more precisely, an alternating current to direct current inverter/rectifier, and high voltage storage batteries connectable to at least one of these DC sub-systems is bi-directional. Current can change direction depending upon whether the vehicle high voltage storage batteries are receiving or supplying power to the motor/generator(s).

High voltage isolation contactors have been used to control the energization and de-energization of the high voltage DC power distribution sub-systems on vehicles and additionally to control the flow of power to vehicle electrical loads. It has been long recognized that the action of opening a high voltage isolation contactor in any direct current circuit can substantially reduce the service life of the contactors due to arcing. As illustrated by U.S. Pat. No. 567,137 to Hewlett, “magnetic blow-out” contactors or circuit breakers have long been in long. Blow-out magnets can urge an electrical arc formed on opening of device contacts along with the magnetic flux lines of the blow-out magnet away from the contacts thereby lengthening and disrupting the arc.

Operation of a high voltage blow-out type isolation contactor is contingent on the contactor being wired “correctly” with regard to polarity of the circuit, that is, the direction current flow. If the polarity of the circuit is opposite of the polarity of the high voltage isolation contactor, then as the contacts begin to open the blow-out magnet's flux lines tend to urge the arc into, instead of away from, the contact area. This reinforces a situation which the blow-out magnets were intended to prevent. High voltage isolation contactors configured with blow-out magnets are quite effective in increasing contactor life in circuits where the polarities of the high voltage circuits are consistent with the polarity of the isolation contactors.

Because current flow on some hybrid electric vehicle DC power buses is subject to changing direction, the polarity of the electrical potential for at least one high voltage distribution sub-system is also subject to change. During the generation mode of a hybrid electric vehicle operation—defined by the traction motor/generator(s) producing sufficient electrical potential to support both the vehicle's immediate electrical needs as well as the electrical needs of the high voltage batteries—the polarity of the high voltage distribution sub-system flows from the traction motor/generator(s) through the high voltage isolation contactors to the high voltage storage batteries and the remaining high voltage distribution sub-systems. This scenario is referred to here as “positive polarity.” Negative system polarity is defined as the flow of electrical potential out of the high voltage batteries through the high voltage isolation contactors to the traction motor/generator(s) as well as the remaining high voltage vehicle architecture.

High voltage power distribution sub-system polarity reversals can occur frequently under certain circumstances. One such scenario is where the traction motor/generator(s) is/are generating power but the rate of power generation is on the borderline of meeting power demands from the vehicle's various electrical loads, for example, electric accessory motors, DC-to-DC converters, truck equipment manufacturer (TEM) integrated body equipment and the like. Under these circumstances it is possible that the polarity on any of the vehicle's high voltage power distribution sub-systems can change in polarity frequently, particularly if the loads on the accessories are changing. This in turn can reduce the effectiveness of the blow-out magnets for the interruption of arcs resulting from opening of the contactors.

### SUMMARY

A method of operating an electrical power distribution system on a hybrid-electric vehicle in which the power distribution system includes at least a first dual mode electrical motor/generator, high voltage traction batteries, bi-directional direct current power transmission lines connectable between the dual mode electrical motor/generator and the high voltage fraction batteries, first and second isolation contactors including magnetic blow out and connected into the power transmission lines to exhibit opposed polarity and an electrical system controller. The method comprises, responsive to a request to deenergize the electrical power distribution system, a step for determining the polarity of current on the bi-directional direct current power transmission lines. Once the polarity has been determined the isolation contactor of corresponding polarity is selected to be opened. Either before or after the selection of a contactor, steps are taken to establish steady state operation of the bi-directional direct current power transmission lines. During steady state operation the polarity of power flow on the transmission lines is to remain unchanged. Then the selected isolation contactor is opened. The non-selected isolation contactor is opened after the selected isolation contactor is opened.

### BRIEF DESCRIPTION OF THE DRAWINGS

FIG. 1 is a high level block diagram of a control system for a hybrid-electric drive train for a motor vehicle.

FIG. 2 is a schematic of a high voltage power distribution system for the drive train of FIG. 1.

### DETAILED DESCRIPTION

In the following detailed description, like reference numerals and characters may be used to designate identical, corresponding, or similar components in differing drawing figures.

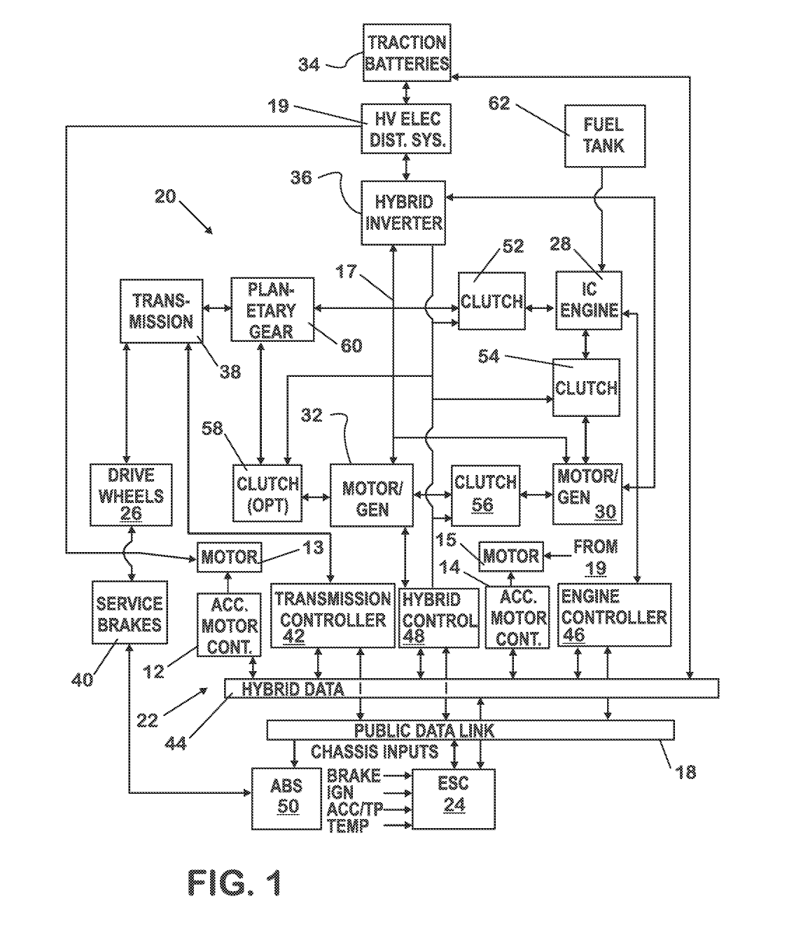

Referring now to the figures and in particular to FIG. 1. FIG. 1 is a generalized a high level schematic of a control system 22 for a hybrid-electric drive train 20 for a vehicle. Hybrid-electric drive trains have generally been of one of two types, parallel and series. In parallel hybrid-electric systems propulsion torque can be supplied to drive wheels by an electrical motor, by a fuel burning engine, or a combination of both. In series type hybrid systems drive propulsion is directly provided only by the electrical motor. Illustration of the methods of isolation contactor control disclosed here is not limited to a particular hybrid-electric system. Hybrid-electric drive train 20 is configurable for series, parallel and blended series/parallel operation and the system operates in any mode. A multiple configuration drive train such as hybrid-electric drive train 22 illustrates numerous possible scenarios by which the drive train can produce polarity reversals within a high voltage power distribution system 19.

Hybrid-electric drive train 20 includes an internal combustion (IC) engine 28 and two dual mode electrical machines (motor/generators 30, 32) which can be operated either as generators or motors. Motor/generator 32 operating alone or together with motor/generator 30 can be used to provide for vehicle propulsion. Either of motor/generators 30, 32 can also generate electricity by regenerative braking of drive wheels 26 or by being driven by the IC 28 engine. In hybrid-electric drive train 20 the IC machine 28 can provide direct propulsion torque or can be operated in a series type hybrid-electric drive train configuration where it is limited to driving one or both of the electrical motor/generators 30, 32. Hybrid-electric drive train 20 also includes a planetary gear 60 for combining power output from the IC engine 28 with power output from the two electrical motor/generators 30, 32. A transmission 38 couples the planetary gear 60 with the drive wheels 26. Power can be transmitted in either direction through transmission 38 and planetary gear 60 between the propulsion sources and drive wheels 26. During braking planetary gear 60 can deliver torque from the drive wheels 26 to the motor/generators 30, 32 or, if the vehicle is equipped for engine braking, to engine 28, distribute torque between the motor/generators 30, 32 and IC engine 28.

A plurality of clutches 52, 54, 56 and 58 provide various options for configuring the electrical motor/generators 30, 32 and the engine 28 to propel the vehicle through application of torque to the drive wheels 26, to generate electricity from electrical motor/generators 30, 32 from the engine, and to generate electricity from the electrical motor/generators 30, 32 by back driving them from the drive wheels 26. Electrical motor/generators 30, 32 may be run in traction motor mode to power drive wheels 26, or they may be back driven from drive wheels 26 to function as electrical generators, when clutches 56 and 58 are engaged. Electrical motor/generator 32 may be run in traction motor mode or generator mode while coupled to drive wheels 26 by clutch 58, planetary gear 60 and transmission 38 while at the same time clutch 56 is disengaged allowing electrical motor/generator 30 to be back driven through clutch 54 from engine 28 to operate as a generator. Conversely clutch 56 may be disengaged and clutch 58 engaged and both motor/generators 30, 32 run in motor mode. In this configuration motor/generator 32 can propel the vehicle while motor/generator 32 is used to crank engine 28. Clutch 52 may be engaged to allow the use of IC engine 28 to propel the vehicle or to allow use of a diesel engine, if equipped with a “Jake brake,” to supplement vehicle braking When clutches 52 and 54 are engaged and clutch 56 disengaged engine 28 can concurrently propel the vehicle and drive motor/generator 30 to generate electricity. Still further operational configurations are possible although not all are used. Elimination of some configurations can allow clutch 58 to be considered as “optional” and to be replaced with a permanent coupling.

The selective engagement or disengagement of clutches 52, 54 and 56 allows hybrid-electric drive train 20 to be configured to operate in a “parallel” mode, in a “series” mode, or in a blended “series/parallel” mode. To configure drive train 20 for series mode operation clutches 54 and 58 (if present) can be engaged and clutches 52 and 56 disengaged. Propulsion power is then provided by motor/generator 32 and motor/generator 30 operates as a generator. To implement drive train 20 for parallel mode operation at least clutches 52 and 58 are engaged. Clutch 54 is disengaged. Motor/generator 32 and IC engine 28 are available to provide direct propulsion. Motor/generator 30 may be used for propulsion. A configuration of drive train 20 providing a mixed parallel/series mode has clutches 52, 54 and 58 engaged and clutch 56 disengaged. Motor/generator 32 operates as a motor to provide propulsion or in a regenerative mode to supplement braking IC engine 28 operates to provide propulsion and to drive motor/generator 30 as a generator.

Hybrid-electric drive train 20 draws on two reserves of energy, one for the electrical motor/generators 30, 32 and a fuel tank 62 for the IC engine 28. Electrical energy for the motor/generators 30, 32 may be stored directly in capacitors but more commonly is sourced from batteries 34. Batteries 34 are subject to charging and discharging. The availability of power from the electrical power reserve may be measured in terms of its state of energization (SOE) or, more usually with batteries, in terms of its state of charge (SOC).

Traction batteries 34 may be charged from external sources or by operation of the drive train 20. As already described, electrical motor/generators 30 and 32 may operate as generators, either together or independently, to supply energy through a hybrid inverter 36 and a high voltage bus 17 of high voltage power distribution system 19 to recharge traction batteries 34. Hybrid inverter 36 provides voltage step down or step up and, if motor/generators 30, 32 are alternating current devices, current rectification and de-rectification between the three phase synchronous motor/generators and battery 34. Fuel from the fuel tank 62 may be converted to electrical energy which is used to charge the traction batteries 34. Traction batteries 34 may also be recharged through regenerative braking.

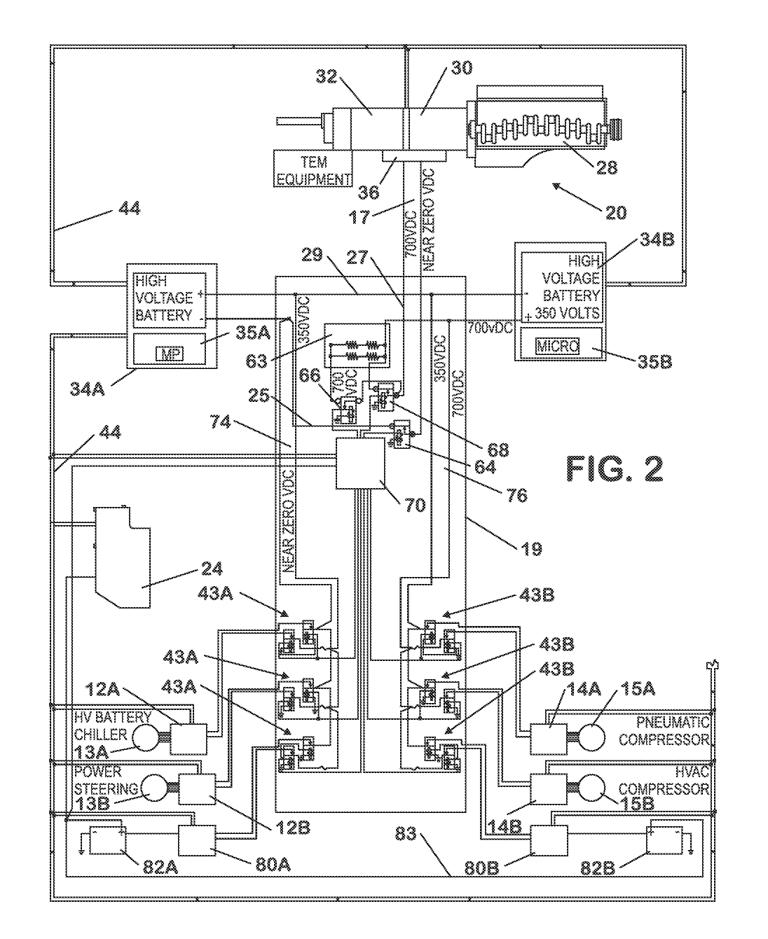

Control over drive train 20, the hybrid inverter 36, fraction batteries 34 and power system 19 isolation contactors 64, 68 (see FIG. 2) is implemented by a control system 22. Control system 22 may be implemented using controller area networks (CAN) based on a public data link 18 and a hybrid system data link 44. Control system 22 coordinates operation of the elements of the drive train 20 and the service brakes 40 in response to operator/driver commands to move (ACC/TP) and stop (BRAKE) the vehicle received through an electronic system controller (ESC) 24. The control system 22 selects how to respond to the operator commands including deenergization of the power distribution system 19 while protecting power distribution system 19 components from damage.

In addition to the data links 18, 44, control system 22 includes the controllers which broadcast and receive data and instructions over the data links 18, 44. Among these controllers is the ESC 24. ESC 24 is a type of body computer and is not assigned to a particular vehicle system. ESC 24 has various supervisory roles and is connected to receive directly or indirectly various operator/driver inputs/commands including brake pedal position (BRAKE), ignition switch position (IGN) and accelerator pedal/throttle position (ACC/TP). ESC 24, or sometime the engine controller 46, can also be used to collect other data such as ambient air temperature (TEMP). In response to these and other signals ESC 24 generates messages/commands which may be broadcast over data link 18 or data link 44 to an anti-lock brake system (ABS) controller 50, the gauge cluster controller 48, the transmission controller 42, the engine control unit (ECU) 46, hybrid controller 48, a pair of accessory motor controllers 12, 14 and through a remote power unit (RPM) 70 to control opening and closing of isolation contactors 64, 66 and 68 as shown in FIG. 2.

Accessory motor controllers 12, 14 control high voltage accessory motors 13, 15 in response to directions from other CAN nodes, primarily ESC 24. High voltage accessory motors 13, 15 are direct current motors employed to support the operation of components such as an air conditioning compressor (not shown), a battery cooling loop pump (not shown) or a power steering pump (not shown). On many hybrid-electric vehicles there is no reasonable option of powering such components directly from the internal combustion engine due to the engine's sporadic availability and the motors 12, 14 driving the accessory components are parasitic loads on a motor/generator 30, 32 when operating in generator mode or on the traction battery 34. The loads produced by these applications can be highly variable, for example, under conditions where a vehicle 102 is caught in slow moving traffic greater demands may be made on power steering. Under conditions of high heat and humidity greater demands are likely to be placed on air conditioning and for battery cooling and thus the motors which drive the compressor pumps used with these systems tend to appear as larger loads the power distribution system 19. Power draw by accessory systems can be reported to ESC 24 over CAN hybrid data link 44.

Operator demand for power on drive train 20 power is a function of accelerator/throttle position (ACC/TP). ACC/TP is an input to the ESC 24 which passes the signal to the hybrid supervisory control module 48. Where engine 28 is supplying power both for propulsion and for charging of the traction batteries 34 an allocation of the available power from engine 28 is made by the hybrid supervisory control module 48.

Referring now to FIG. 2, control over the energization state or, put more particularly, de-energization of portions of the high voltage electrical power distribution system 19 through operation of isolation contactors 64 and 68 is discussed. High voltage electrical power distribution system 19 includes three sub-systems 17, 74, 76. The power distribution sub-systems 17, 74, 76 are formed from several electrical conductors. A near ground conductor 27 is connected to a grounded terminal of high voltage fraction battery 34A through isolation contactor 64 to one terminal of inverter 36. The positive (normally the ungrounded terminal) of traction battery 34A is connected by a high voltage conductor 29 to the negative terminal of traction battery 34B. The positive terminal of traction battery 34B is connected through a resistor pre-charge circuit 63 to isolation contactor 68 and from there to the remaining terminal of inverter 36 by a high voltage conductor 27. Electrical current transmission over the conductors 25, 27, 29 is direct current, but bi-directional. The direction of flow depends upon whether current is being sourced by traction battery packs 34A, 34B or flowing into the traction battery packs.

Sub-system 17 carries a DC potential of 700 volts between near ground conductor 25 and high voltage conductor 27 when the sub-system is energized. Sub-system 74 supports a potential of 350 volts between high voltage (350 volt) conductor 29 and the near ground conductor 25. Sub-system 76 supports a potential of 350 volts between the high voltage (350 volt) conductor 29 and the high voltage (700 volt) conductor 27.

High voltage power distribution system 19 may be de-energized by opening either of isolation contactors 64, 68. Isolation contactor 64, 68 are of a fixed polarity design. They are equipped with magnetic blow-outs for suppression of arcing during opening of the contactors. First isolation contactor 64 is physically in a series relationship with the near ground conductor 25 between battery pack 34A and inverter 36. Second isolation contactor 68 is in a series relationship within conductor 27 with the positive terminal of traction battery 34B and inverter 36. The high voltage isolation contactors 64, 68 are oriented in an opposing/reversed polarity relationship (one with regards to the other) within the circuit.

When batteries 34A, 34B are discharging power flow is into inverter 36. When batteries 34A, 34B are being charged power flow is out of inverter 36. Reversal of the direction of current flow through the isolation contactors 64, 68 can depend changes in whether inverter 36 is drawing or sourcing power. If hybrid inverter 36 is drawing power then batteries 34A and 34B are sourcing power. It is possible that batteries 34A, 34B and hybrid inverter 36 will concurrently source power, particularly during periods of mild regenerative braking and heavy loads. It is during such periods that the possibility of frequent reversal of current flow can arise.

Battery management systems (BMS) 35A, 35B monitor the electrical potential flowing into and out of the high voltage battery packs 34A, 34B. This data is reported by the BMS 35A, 35B over the controller area network (CAN) data link 44. High voltage accessory loads connected to power sub-systems 74, 76 include controllers and these can report load status and power draw over data link 44. Among these systems are motor controller 12A for a high voltage battery chiller motor 13A, DC-to-DC converters 80A, 80B for a low voltage power distribution system 83 and low voltage batteries 82A, 82B, motor controller 12B for power steering pump motor 13B, a motor controller 14A for a pneumatic compressor motor 15A and motor controller 14B for an HVAC (heating, ventilation and air conditioning) compressor motor 15B. ESC 24 monitors the BMS 35A, 35B and load status data on the data link 44.

The direction of current flow is determined by ESC 24 depending upon reports generated by battery management systems (BMS) 35A, 35B for the traction battery packs 34A, 34B. In order to deenergize the high voltage power distribution system 19 one of isolation contactors 64, 68 to be opened first depending upon the direction of flow of current. For a power down operation the data is used by ESC 24 to select the correct one of isolation contactors 64 or 68 to open taking into account the present polarity of the direct current flowing within the circuit.

Once the polarity of current flow on the conductors 25, 29 has been identified and the appropriate one of isolation contactors 64, 68 has been selected, ESC 24 commands all high voltage devices associated with the targeted circuit to assume a “steady state” condition in order to maintain the correct energy polarity relationship within the circuit and the selected isolation contactor until the selected isolation contactor can be opened. Typically a steady state period occurs with accessory loads already minimized, although this is not always the case. The duration of the steady state period is usually quite brief, on the order of a few microseconds and thus adverse consequences stemming from steady state operation should be minimized. During a steady state period the polarity of the current flow in conductors 25, 27, 29 is maintained. This may require load management to adjust to changes in the amount of power sourced from hybrid inverter 36 and/or changes in the amount of power generated by motor/generators 30, 32. In addition, it is possible that traction battery packs 34A, 34B may be undergoing charging at near the maximum state of charge when a steady state is locked. The degree to which traction battery 34A, 34B can be overcharged during the short duration steady state will be minimal. The remaining, non-selected isolation contactor 64 or 68 is opened a short period after the selected isolation contactor has opened.

Establishing a steady state condition prevents a change of polarity in the conductors 25, 27 prior to opening the selected one of the isolation contactors 64, 68. A polarity change occurring during the transitioning of the selected isolation contactor can result in failure to suppress an arc developed within the high voltage isolation contactor. Repeated occurrences of arcing, particularly sustained arcing, contribute to damage to the high voltage isolation contactors 64, 68. Once the first isolation contactor has been transitioned open the second isolation contactor (opposing polarity) will subsequently be transitioned open. As a result, the second isolation contactor will not be subject to damage due to the absence of energy flow within the circuit despite the fact that magnetic blowout was positioned in reverse polarity at the point in time when the ESC 24 commanded the first contactor to transition to its open state. Accessory isolation contactors 43A, 43B used to connect accessory controllers and motors to power distribution sub-systems 74, 76, respectively, are held in the current state during the steady state period. During the steady state period the various accessories can be operated in a fashion so as to exhibit a constant load. For example, the pneumatic compressor motor 15A is operating when the steady state period begins it will continue to operate as long as the steady state period remains in effect. This can possibly result in a slight over pressurization of compressed air storage tanks on a vehicle.

Consideration is given the high voltage battery 34A, 34B SOC “dynamic margin” needed to maintain a steady power state condition in anticipation of selecting the correctly polarized isolation contactor for the current polarity of the conductors 25, 27. For example: the normal upper and lower state of charge (SOC) values for the beginning and ending of a high voltage battery recharge/regeneration cycle may be normally in the 85%-25% SOC area. However, during the ESC 24 selection process the SOC range may be increased to 87%-23% SOC to allow for the additional energy inflows or outflows which may be incurred during the steady state interval.

1. An electrical power system comprising:
a rechargeable energy storage system;
means for charging the rechargeable energy storage system;
means for providing bi-directional direct current electrical power transmission between the means for charging and the rechargeable energy storage system;
a control system responsive to requests for changes in state of the electrical power distribution system for determining polarity of power flow on the bi-direction electrical power bus;
first and second isolation contactors providing magnetic blow out arc interruption in the means for providing, the first and second isolation contactors being connected into the means for providing so as to exhibit opposed polarities; and
the control system being further responsive to a request for a change of state of the electrical power distribution system from on to off and to determination of the polarity of power flow for selecting one of the first and second isolation contactors to open first.

2. The electrical power system of claim 1, further comprising:
the control system including programming means for initiating a steady state period of limited duration during which loads connected to the electrical power distribution system are managed to maintain the polarity of power flow.

3. The electrical power system of claim 2, wherein: the rechargeable energy storage system comprises electrical storage batteries; and
the means for charging includes at least a first dual mode electrical motor/generator.

4. The electrical power system of claim 3, further comprising:
the steady state period having a predetermined maximum duration.

5. The electrical power system of claim 4, further comprising:
the steady state period includes management of the dual mode electrical motor/generator.

6. A method of operating an electrical power system on a hybrid-electric vehicle, the
electrical power distribution system including at least a first dual mode electrical motor/generator, high voltage traction batteries, bi-directional direct current power transmission lines connectable between the dual mode electrical motor/generator and the high voltage traction batteries, first and second isolation contactors including magnetic blow out and connected into the power transmission lines to exhibit opposed polarity and an electrical system controller, the method comprising the steps of:
responsive to a request to deenergize the electrical power distribution system determining the polarity of current on the bi-directional direct current power transmission lines;
selecting one of the first and second isolation contactors to open;
establishing a steady state for the bi-directional direct current power transmission lines during which polarity remains unchanged; opening the selected isolation contactor; and
thereafter opening the non-selected isolation contactor.

7. The method of claim 6, further comprising:
the steady state having a predetermined maximum duration.

8. The method of claim 7, further comprising a step of:
managing loads connected to the power distribution system to maintain the steady state.

9. A hybrid vehicle comprises:
a rechargeable energy storage system;
electrical motor/generators for charging the rechargeable energy storage system;
means for providing bi-directional direct current electrical power transmission between the electrical motor/generators and the rechargeable energy storage system;
a control system responsive to requests for changes in state of the electrical power distribution system for determining polarity of power flow on the bi-direction electrical power bus;
first and second isolation contactors providing magnetic blow out arc interruption in the means for providing, the first and second isolation contactors being connected into the means for providing so as to exhibit opposed polarities; and
the control system being further responsive to a request for a change of state of the electrical power distribution system from on to off and to determination of the polarity of power flow for selecting one of the first and second isolation contactors to open first.

10. The hybrid vehicle of claim 9, further comprising:
the control system including programming means for initiating a steady state period of limited duration during which loads connected to the electrical power distribution system are managed to maintain the polarity of power flow.

11. The hybrid vehicle of claim 10, wherein:
the rechargeable energy storage system comprises electrical storage batteries.

12. The hybrid vehicle of claim 11, further comprising:
the steady state period having a predetermined maximum duration.

13. The hybrid vehicle of claim 12, further comprising:
the steady state period includes management of the electrical motor/generator.
